(19) United States
(12) Patent Application Publication
(10) Pub. No.: US 2015/0232216 A1
(43) Pub. Date: Aug. 20, 2015

(54) Stacking of Gloves

(71) Applicant: ALTEVO LIMITED, Woodbridge (GB)

(72) Inventors: Jonathan William Stollery, Woodbridge (GB); Kim Marie Stollery, Woodbridge (GB)

(21) Appl. No.: 14/426,981

(22) PCT Filed: Aug. 23, 2013
(86) PCT No.: PCT/GB13/52228

§ 371 Date: Mar. 9, 2015

(30) Foreign Application Priority Data
Sep. 10, 2012 (GB) 1216119.6

(51) Int. Cl. B65B 35/50; B65G 57/03; B65B 63/02; B65B 5/06; B65B 25/20

(52) U.S. Cl. CPC B65B 35/50; B65B 5/06; B65B 25/20; B65B 63/02; B65G 57/03

(57) ABSTRACT

The present invention relates to a glove stacking apparatus that has a receptacle into which gloves are placed for preparing a stack of gloves prior to packing into a container such as a glove dispensing box, and to a method of stacking gloves prior to packing into a container.

### BACKGROUND

a. Field of the Invention

The present invention relates to a glove stacking apparatus that has a receptacle into which gloves are placed for preparing a stack of gloves prior to packing into a container, for example a glove dispenser, and to a method of stacking gloves using such a glove stacking apparatus for preparing a stack of gloves prior to packing into a container.

b. Related Art

Disposable hygienic gloves, in particular ambidextrous medical examination gloves, are used in vast numbers in hospitals, clinics, and doctors' surgeries. Such gloves are often ambidextrous and are supplied not in individual sterile packages, but packed inside a glove dispenser, for example an inexpensive card material dispensing box that has one or more dispensing apertures through which gloves can be pulled out one at a time by a user. To help control infection and the rise of infectious bacteria resistant to multiple antibiotics, it is important that the user does not touch the finger portion of the gloves as these are being donned. Therefore, gloves are preferably dispensed cuff first. Examples of cuff first glove dispensing systems are disclosed in GB 2449087, GB 2457450 and GB 2454753. Gloves are packed in an inexpensive box, made from card material and having a removable cover over an opening. Each of the stacked gloves may be packed flat or folded over on itself and with the cuff of each glove being presented towards the opening. However, it is preferable if the gloves are interfolded with the finger portion of each glove wrapping behind the cuff portion of the next glove so that each cuff is pulled partially out of the dispensing opening by the finger portion of the glove being dispensed.

Gloves may either be packed directly in a glove dispenser or may be enclosed in a packet, for example a cardboard sleeve or a plastic bag prior to packing or loading into a glove dispenser, for example a glove dispensing box.

It is also important that gloves are frequently changed to avoid cross-contamination. The size of boxed gloves is an issue owing to the need to minimise the space needed to store gloves, or the size of dispensing apparatus holding boxed gloves. For convenience, dispensing boxes may be held in a wall-mounted or horizontal surface-mounted holder. It is preferable that the dispensing boxes hold as many gloves as possible, to minimise the frequency with which a fresh dispensing box has to be provided.

In order to maximise the number of gloves than can be packed in a box, it is important that gloves are stacked as uniformly as possible, and also that as much air as possible is expelled from within the stack. It has therefore been proposed to use a packing receptacle into which gloves are inserted. Inside the receptacle is a floor which supports the stack of gloves and which moves downwards as the stack of gloves grows so that gloves are deposited on the stack at or about the level of the top of the packing receptacle. In this way, as the floor descends, the stack of gloves is contained by side surfaces or walls of the packing receptacle.

Such a packing receptacle is disclosed in WO/2010/020782 and WO/2011/048417. The type of packing receptacle works well as the stack is growing, but a problem can arise when the stack is to be ejected upwards from the receptacle for insertion into a container, which may be either a glove dispenser or the plastic bag or card material to form a packet for subsequent loading into a glove dispenser. Gloves are flexible, relatively thin and have a relatively high coefficient of friction. As a result, after the stack has reached its full height and when the base starts to move upwards, it is possible that the portions of the gloves in the periphery of the stack nearest the floor will drag against the inner surfaces of the receptacle containing the stack and fall into and get trapped in the gap between the edge of the floor and an inner surface of the packing receptacle. The solution to this problem, as proposed in the prior art, is to form the movable base such that there is a clear gap between the base and the inner surfaces of the packing receptacle, with the gap extending fully around the floor surface and for some distance also at a level beneath the base surface. Then, if any portions of the glove are pulled into this gap as the base moves upwards, the clearance between the base and adjacent inner surfaces of the receptacle and the depth of the gap are both sufficient so that peripheral portions of the stack do not get caught between the upwardly moving base and inner surfaces of the receptacle.

This arrangement works well when forming a stack consisting of about 100 to 200 disposable, interfolded, nitrile or latex gloves of standard thickness (rated at 9 Netwons tear strength). In the prior art, a stack of 100 gloves can then be inserted into a card material box having external dimensions of about 130 mm wide by 120 mm deep by 130 mm high. A stack of 200 disposable interfolded nitrile or latex gloves of thinner thickness (rated at 6 Newtons tear strength) can be inserted into a card material box having external dimensions of about 130 mm wide by 120 mm deep by 165 mm high. In this specification, the term “card material” means material such as cardboard, a plastic card material or any other suitable disposable thin sheet material.

The inventors have found that, in a machine stacking process similar to that described in WO/2011/048417, up to 500 disposable interfolded nitrile gloves of thinner thickness (rated at 6 Newtons tear strength), when sufficiently compressed after stacking to remove excess air, can be inserted into a card material box having external dimensions of about 130 mm wide by 120 mm deep by 230 mm high. This height of box is standard for several types of known glove box holder. This is double the number of gloves that would normally be provided in a dispensing box having these dimensions. Providing this many gloves inside a single box is a great convenience in a clinical or medical work place.

The inventors have noticed a problem when using the known types of packing receptacle to form taller stacks consisting of up to 500 of such gloves. In this case, the friction between the stack and the inner surfaces of the receptacle becomes so great that the stack does not move downwards evenly as the floor is lowered, and it also becomes difficult to eject the stack.

It is possible to reduce the friction by increasing the internal horizontal dimensions of the receptacle, but this also reduces the ability of the receptacle inner surfaces to contain and define the outer boundaries of the stack of gloves. The result of this is that the stack is wider such that this will no longer fit inside a dispensing box having dimensions of about 130 mm wide by 120 mm deep.

It is an object of the present invention to provide glove stacking apparatus having a receptacle into which gloves are placed for preparing a stack of gloves prior to packing into a glove dispensing box, and to a method of stacking gloves using such a glove stacking apparatus for preparing a stack of gloves prior to packing into a container, which addresses these issues.

### SUMMARY OF THE INVENTION

According to the invention, there is provided glove stacking apparatus for preparing a stack of gloves prior to packing into a container, comprising a receptacle inside of which said stack is to be formed, the receptacle comprising:
an opening to the receptacle for receiving gloves added to said stack of gloves;
a floor within the receptacle, the floor being opposite the opening for supporting said stack of gloves and being movable relative to the opening, so that, in use, the floor may be moved relatively away from said opening so that as gloves are added to said stack of gloves said stack remains within the receptacle and so that when the stack of gloves is complete the floor may be moved relatively toward said opening to remove the stack of gloves from the receptacle, the movement of said floor within the receptacle thereby defining a packing axis of the receptacle; and
a plurality of sides, said sides defining said opening and having corresponding side surfaces that extend away from the opening for containment of said stack within the receptacle;
wherein at least one of said sides surfaces comprises a first portion proximate said opening and a second portion that is relatively farther away from said opening than said first portion, said side having an angled side surface that is at an angle to the packing axis such that said angled surface extends inwardly towards the packing axis from said second portion towards said first portion of said side.

In one embodiment of the invention, the angled surface is angled away from the packing axis at an acute angle. The packing axis is preferably vertical or substantially vertical, so that the stacked gloves are supported from underneath by the floor and are retained in the receptacle by gravity.

Because the overall shape of the stack in terms of width and depth is determined by the orientation of the gloves deposited at the opening and by contact with the opening, the angled surface provides greater space between the stack of gloves and the receptacle inner surface. This reduces friction between the receptacle inner surfaces and the stack of gloves as the floor moves away from the opening as the stack is built up. At the same time, the contact between the stack of gloves and one or more surfaces around the receptacle opening stabilises the orientation of the stack of gloves, and prevents this from sagging or moving to one side, even if the angle and extent of the inner surface is sufficiently large for there to be no contact between the stack of gloves and the receptacle inner surfaces between the angled surface and the descending floor.

It has been found that with the prior art apparatus for preparing a stack of interfolded gloves disclosed in WO/2010/020782 and WO/2011/048417, that about 75% to 80% of the friction between the stack of gloves and the receptacle inner surfaces is on the two opposite sides of the receptacle in contact with the two opposite folded sides of the stack of gloves. This is because the stack of gloves will contain a concentration of material along the glove fold lines. Therefore, it is most preferable if the angled surfaces are provided on at least the two sides of the receptacle against which the folded sides of the glove stack may make contact.

The stack may, to some extent, spread laterally into the space afforded by the angled surface. The angled surface can therefore advantageously be used to compress inwardly the completed stack of gloves as the stack is moved towards the opening by the movable floor. This lateral compression, and the frictional resistance between the upwardly moving stack of gloves and the inner surface nearest the opening, will result in resistance against the upwards force applied to the stack by the relative movement of the floor and the receptacle side walls. This will compress the stack of gloves in the direction of this movement, which will result in air being expelled from the stack.

In one embodiment the, or each, side having the angled surface comprises a first portion that is parallel with the packing axis. This first portion is proximate the opening such that the angled surface extends from the first portion in a direction away from the opening.

The angled surface may be a ramp between adjacent side surface portions, with these adjacent portions being substantially parallel with the packing axis.

The adjacent portions may comprise a first portion nearest the receptacle opening and a second portion farthest from the opening. In order to maximise the reduction in friction, the length of the second portion in a direction parallel to the packing axis is preferably at least 10 times the length of first portion parallel to the packing axis.

The length of the angled surface in the direction of the packing axis may then be less than or equal to the length of the first portion in the same direction.

In the case where the angled surface is a ramp between adjacent side surface portions that are substantially parallel with the packing axis the angled surface may be set at an angle of between 15° and 30° to the packing axis. In this case, an angle less than this range provides a decreased benefit in terms of friction reduction, and an angle greater than this range creates increased resistance as the glove stack is compressed laterally by the angled surface. In a preferred embodiment of the invention, the angled surface of this ramp is set at an angle of between 20° and 25° to the packing axis.

In a preferred embodiment, the receptacle has four sides, and the first portion forms a band that extends across at least two of these sides. The sides may comprise at least two opposite sides of the receptacle.

The side surfaces may, however, have one or more breaks or slots provided therein, for example being formed by separate plates, sheets or rails that extend from the receptacle opening in a direction towards the floor, and so it is not necessary that this band be continuous.

In an alternative embodiment of the invention, the angled surface extends substantially the full distance between the opening and floor when the floor is moved away from the opening, the angled surface being set at an angle of between 0.3° and 1.5° to the packing axis. Most preferably, this angled surface is set at an angle of between 0.9° and 1.1° to the packing axis. In this case, instead of being a ramp portion, the angled surface is a sloping surface that extends substantially the full distance between the opening and floor when the floor is moved away from the opening.

The movable floor may be provided by a base, the apparatus comprising additionally an actuator that is arranged to move the base towards the opening when the stack is completed. The base may then have dimensions such that the base does not contact the receptacle side surfaces as the stack is moved towards the opening. Most preferably, the base is separated from the side surfaces by a gap which is sufficiently large that portions of gloves nearest the floor do not drag on side wall surfaces and become trapped between the base and the side surfaces as the completed stack is moved towards and through the receptacle opening.

In a further embodiment of the invention, the angled surface is a step that extends substantially perpendicular to the packing axis. The step may then be between adjacent portions of the side surface, these adjacent portions being substantially parallel with the packing axis.

In some embodiments of the invention, the first portion may be removeably attached to the second portion so that the angled surface can be removed from the receptacle in order to aid the removal of the stack of gloves when the floor is moved relatively towards the opening.

In all preferred embodiments, the receptacle proximate the opening is a sleeve having outer side surfaces. The shape of the outer side surfaces parallels the shape of the side surfaces inside the sleeve so that at least one of the outer side surfaces comprises an angled outer surface of the sleeve, corresponding with one or more of the angled inner surfaces.

The apparatus may comprise additionally a container for receiving the stacked gloves. The container may be a packing box into which the stacked gloves are transferred prior to a final transfer into a glove dispensing box, or the container may be a glove dispensing box. The container may also be a plastic bag or card material sleeve that wraps around the stack of gloves to form a packet for subsequent loading into a reusable glove dispenser. The container has an opening for receiving therein the sleeve so that the completed stack of gloves can be transferred to the container as the floor is moved towards the opening of the receptacle. The opening of the container then rests on the, or each, angled outer surface of the sleeve when the sleeve is received inside the opening of the container.

The container may just be a packing box, used as an intermediate packing stage, prior to final insertion of the stack of gloves into a card material glove dispensing box. In a further embodiment of the invention, the container may be a packing box that holds inside a card material box which then receives the stack of gloves directly. In another embodiment of the invention, the container may be a packing box that holds inside a plastic bag or a card material sleeve that is used to form a packet for subsequent loading into a reusable glove dispenser. The packing box is preferably made from relatively strong material which can withstand the compressive force that is applied as the completed stack is pressed fully within the packing box or card material box, plastic bag or card material sleeve held inside the packing box.

The invention also provides a method of using a glove stacking apparatus to prepare a stack of gloves prior to packing into a glove dispensing box, the apparatus comprising a receptacle having an opening and a floor opposite and relatively movable with respect to said opening and inside said opening a plurality of sides, said sides extending around the opening and having corresponding side surfaces and at least one of said side surfaces including an angled surface that forms an overhang within the receptacle, the method comprising the steps of:
inserting gloves one or more at a time through the opening and into the receptacle to build a stack of gloves that is supported by the floor, said stack having a height that extends from the floor towards the opening and a width and having a depth in orthogonal directions that are perpendicular to the height of the stack, at least one of the width and depth of the stack being defined by contact between said stacked gloves with at least one side around the opening; and
moving the floor as necessary away from the opening as the stack of gloves is built up so that said stack continues to be contained within the receptacle; wherein friction owing to said contact between said at least one side and the stack of gloves is relieved for those gloves which pass the overhang as the floor is moved relatively away from the opening.

The method may comprise, when the stack of gloves is complete, moving the floor towards the receptacle opening in order to remove the completed stack from the receptacle and during this removal using the overhang to compress inwardly those gloves which had previously passed the overhang as the floor was being moved away from the opening.

The method may involve the step of using the frictional contact between the, or each, side and the stack of gloves where there is frictional contact to resist the movement of the completed stack towards the opening in order to compress the stack between the floor and the overhang. This will then expel air from within the stack, and thereby reduce the height of the completed stack as this is moved out of the receptacle.

The apparatus may comprise a container, the container having a base therein and opposite this base an opening. The method then may comprise the steps of:
placing the container opening over the receptacle opening;
receiving said stack within the container as the floor moves relatively towards the opening; and
using the movement of the floor to compress the received stack against the base inside the container and thereby expel air from within the stack.

By expelling air, the height of the stack is further compressed, which increases the number of gloves which can subsequently be packed inside a card material glove dispensing box or other similar type of glove dispenser.

In preferred embodiments of the invention, the receptacle has four sides with corresponding side surfaces within the receptacle and the overhang provided by the angled surface extends on all four of these inner side surfaces. At least one of the width and depth of the stack is defined by contact between the stacked gloves with at least two opposite sides around the opening. The method then comprises the step of using contact between the stacked gloves with the two or more sides around the opening to stabilise the orientation of a portion of the stack between the overhang and the movable floor.

The floor may be moved downwardly by pressure applied to the top of the stack as each glove is deposited, however, it is preferred if the floor moves downwards under the action of its own actuator by a predetermined amount according to the number of gloves that are deposited.

Because the invention permits air to be efficiently expelled after completion of the stack, it is not necessary that the stack is held under compression during the stacking process. The stack of gloves can therefore be loosely stacked and air expelled by frictional contact with the overhang during upwards movement of the stack, and also by compression of the stack against a base surface inside a container.

The apparatus described above may be used as part of an automated glove lifting and placement apparatus, as described in the prior art. Therefore, the apparatus may be part of a glove stacking station where the receptacle is a receptacle in a work surface. Glove placement means similar to that described in WO/2011/048417 may be used with the glove stacking apparatus. The glove placement means is then arranged to deposit gloves above the receptacle for stacking within the receptacle. The receptacle side walls help to align gloves stacked one on another inside the receptacle. Normally, the side walls will be fixed and the floor will be movable so that the floor and receptacle inner surfaces are movable with respect to each other, although this movable arrangement could be reversed. The movable floor is then lowered as the stack of gloves grows so that the topmost glove in the stack of gloves remains substantially level with the work surface.

The apparatus may also comprise at least one movable flap adjacent an edge of the receptacle for folding towards the receptacle a portion of a glove overlapping the edge of the receptacle. The flap is preferably hinged adjacent the edge of the receptacle.

The receptacle opening may be substantially square or rectangular. There is preferably a pair of flaps on opposite side edges of the opening for folding alternately inwards to the opening, portions of gloves overlapping alternately one or another of the opposite side edges of the opening.

Gloves are preferably deposited at the receptacle such that a portion of the glove is contained by the receptacle and another portion of the deposited glove overlaps an edge of the receptacle and lies on at least one movable flap. The movable flap is then moved to fold towards the receptacle the portion of the glove that overlaps the edge of the receptacle so that the glove is contained by the receptacle. During this process, the flap preferably contacts the stack of gloves formed in the receptacle in order to help move the gloves downwards.

If the friction between the side surfaces and glove stack is reduced according to the invention, then it has been found that the movable flaps can provide sufficient downward force to keep the top of the stack approximately level with the receptacle opening as the floor moves away from the opening. The apparatus and method according to the invention therefore does not need any interaction between the glove placement means and the top of the stack in order to keep the stack moving into the receptacle. This greatly simplifies and speeds up the operation of the glove placement means, which then does not need to make any contact with the top of the stack of gloves.

### BRIEF DESCRIPTION OF THE DRAWINGS

The invention will now be further described, by way of example only, and with reference to the accompanying drawings, in which:

FIG. 1 is a perspective view of a receptacle inside of which a stack of gloves is to be formed, for use as part of a glove stacking apparatus according to a first embodiment of the invention, for preparing a stack of gloves prior to packing into a glove dispensing box, the receptacle having continuously tapering side walls;

FIG. 2 is a perspective view of a receptacle inside of which a stack of gloves is to be formed, for use as part of a glove stacking apparatus according to a second embodiment of the invention, for preparing a stack of gloves prior to packing into a glove dispensing box, the receptacle having side walls with corresponding ramp surfaces;

FIG. 3 is a schematic cross section, showing the use of the receptacle of FIG. 2 in a glove stacking apparatus, the receptacle having a movable floor and being bounded by a work surface that includes a pair of inwardly moveable flaps for interfolding gloves deposited at the top of the stack of gloves;

FIG. 4 is a schematic cross section, showing the receptacle of FIG. 3 after filling with gloves, which are then moved past the angled surface and out of the receptacle into a container into which the completed stack is compressed in order to expel air from the stack;

FIG. 5 is a perspective view of a receptacle inside of which a stack of gloves is to be formed, for use as part of a glove stacking apparatus according to a third embodiment of the invention, for preparing a stack of gloves prior to packing into a glove dispensing box, the receptacle having inwardly stepped side walls, the step being formed by a removable end portion of the receptacle;

FIG. 6 is a schematic cross section similar to that of FIG. 3, showing the use of the receptacle of FIG. 5 in a glove stacking apparatus; and

FIG. 7 is a schematic cross section, showing the receptacle of FIG. 6 after filling with gloves and after removal of the end portion, the gloves then being moved out of the receptacle into a packing box which has an angled surface which helps to laterally compress the gloves as these are pressed into the packing box.

### DETAILED DESCRIPTION

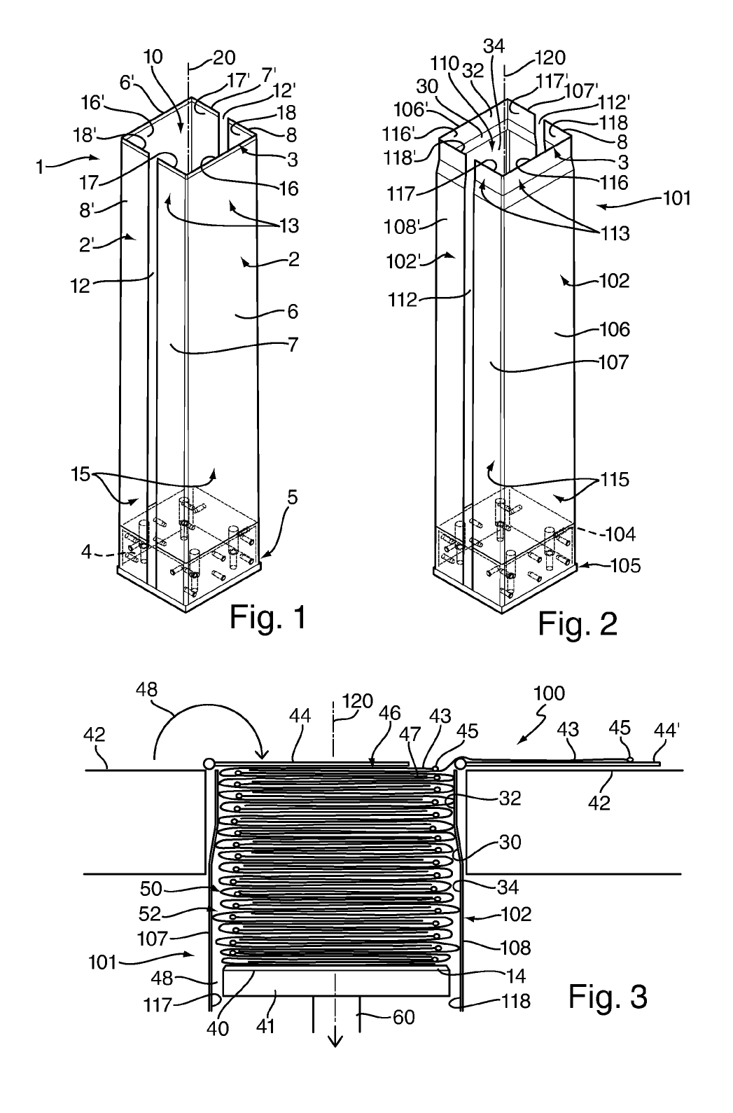

FIG. 1 is perspective view of a first embodiment of a receptacle 1 for use in a glove stacking apparatus. The receptacle 1 is formed from a pair of similar sleeve halves, 2, 2′, bolted together at a base 4. The sleeve halves each have one continuous side wall 6, 6′ which is central between a pair of similar partial side walls 7, 8, 7′, 8′. At a first end 3 of the sleeve halves is an opening 10, which in this example is substantially rectangular or nearly square. At an opposite end 5 of the sleeve is the base 4. The arrangement is such that the continuous side walls 6, 6′ are on one pair of opposite sides of the rectangular opening 10 defined by the receptacle, and the partial side walls 7, 8, 7′, 8′ are on another pair of opposite sides of the rectangular opening.

Each side wall has a first portion (generally indicated by reference numeral 13) proximate the first end 3 and a second portion (generally indicated by reference numeral 15) farther away from the first portion 13.

The partial side walls of the two sleeve halves 2, 2′, where these come closest on opposite side walls, are each separate by a slot 12, 12′. When viewed from above the sleeve halves have the shape of a pair of inwardly facing square C-sections. The slots preferably extend the full length of the sleeve halves 2, 2′. The slots 12, 12′ are used to accommodate a packing plate 14 (see FIG. 3). The packing plate is similar to that disclosed in WO/2010/020782 and WO/2011/048417, and will therefore not be described in detail here.

The sleeve halves 2, 2′ when assembled provide corresponding inner side surfaces 16, 17, 18, 16′, 17′, 18′ that extend away from the opening 10 for containment of the stack within the receptacle. The side surfaces are angled at a constant angle of between about 0.9° and 1.1° to a substantially vertical packing axis 20 which is also a longitudinal axis of the assembled sleeve halves so that the receptacle 1 is narrowest in terms of width and depth at right angles to the packing axis, nearest the opening 10, and becomes wider further away from the opening. The side surfaces therefore taper outwards in a direction extending away from the opening, which creates an overhang 22 in the receptacle at or beneath the opening.

Another way of describing this is to say that angled side surfaces are each at an angle to the packing axis 20 such that these angled surfaces extends inwardly towards the packing axis from the second portion 15 towards the first portion 13 of each side.

FIG. 2 is perspective view of a second embodiment of a receptacle 101 for use in a glove stacking apparatus 100. In the second embodiment features of the receptacle which correspond with those of the first embodiment are indicated by reference numerals incremented by 100.

The second embodiment of the receptacle 101, differs from the first embodiment 1, in that the inner surfaces 116, 117, 118, 116′, 117′, 118′ of the partial side walls 107, 108, 107′, 108′ each have an angled surface that extends not over the full length of the side walls, but only over a band 30 in each inner surface that is relatively narrow in the direction of the axis 120. In the first embodiment 1, the first and second side wall portions 13, 15 extend into each other. In the second embodiment 101, the band 30 defines the separation between the first and second side wall portions 113, 115.

Either side of the band is a wider band 32, 34 that is parallel to the axis 120. The drawing of FIG. 2 shows that the extent of the angled band 30 is less than one tenth the width of the parallel band 34 on the side of the angled band away from the opening 110, and is also less than the width of the parallel band 32 nearest the opening. The angled surface is set at an angle of between 20° and 25° to the packing axis 120.

FIG. 3 shows the use of the receptacle 101 of FIG. 2 in a glove stacking apparatus 100, the receptacle having a movable floor 40, provided by a movable base 41, and being set inside a work surface 42 that includes a pair of inwardly moveable flaps 44, 44′ for interfolding gloves 46 deposited at the top of a stack of gloves 50. Preferably, the gloves do not rest directly on the floor, but on a packing plate 14, as described in the prior art acknowledged above.

The same arrangement of movable floor 40, movable base 41, work surface 42, inwardly moveable flaps 44, 44′ and packing plate 14 may be used with the first embodiment of the receptacle 1 described above, and so this will not be separately described in detail.

Each glove 46 has a cuff portion 43 for covering the wearer's wrist, palm and back of hands and which is therefore nearest a glove cuff, indicated schematically by open circles 45, and a finger portion 47 for covering the wearer's fingers and thumb. An automated apparatus such as that disclosed in WO/2011/048417 may be used to deposit gloves one at a time such that each glove lies partly over the receptacle and alternately over one or the other of the flaps 44, 44′ adjacent the receptacle. In FIG. 3, the gloves are shown being interfolded with each cuff portion being folded over the finger portion of the glove previously deposited. This creates a stack suitable for cuff-first dispensing from the top of the stack as drawn in FIG. 3.

It is also, however, possible for gloves to be deposited such that the cuff portion of each deposited overlies the receptacle and the finger portion of each deposited glove overlies alternately one or the other of the flaps, as shown in the embodiment of FIG. 6, which will be discussed in more detail below. This creates a stack suitable for cuff-first dispensing from the opposite end to that of FIG. 3. The choice of which of these ways to interfold gloves will depend on the orientation of a dispensing opening in the container, glove dispenser or packet into which the stack of gloves is ultimately to be packed.

The position of fold lines in the gloves are defined by the motion 48 of the flaps 44, 44′, and also by contact with the parallel band 32 of the receptacle inner side surfaces—116, 117, 118, 116′, 117′, 118′. The placement of gloves by automated glove handling equipment is not perfect and this contact ensures that the stack does not spread too much in a lateral direction. There is a similar contact (not shown) in a plane at right angles to the drawing of FIG. 3, along the sides of glove cuff and finger portions 43, 47.

To relieve friction as the glove stack descends, the angled band 30 provides an overhang around all four sides of the receptacle inner surfaces. This allows a gap 52 to open up between the glove stack side surfaces, although there may still be some residual contact, which may also provide some benefits in terms of providing lateral stability of the stack, particularly when the stack is pressed upwards at the end of the stacking process. The result is to greatly reduce friction between the stack and inner receptacle surfaces when as the stack is moved away from the opening. Therefore, the action 48 of the flaps 44, 44′ is sufficient to keep the top of the stack approximately level with the opening 110, as the floor moves down automatically under the action of a linear actuator 60 by a pre-set amount for each deposited glove.

The receptacle 1 of the first embodiment works in a similar way, except that the corresponding gap opens up more gradually moving away from the opening 10.

In this way an interfolded stack of gloves 50 for cuff first dispensing from a box dispenser, can be built up automatically. During dispensing, the cuff of the glove being dispensed is gripped and removed from a container (not shown), and as the fingers of that glove are pulled out of the container, the fingers of that glove pull out the cuff of the next glove for dispensing.

When sufficient gloves have been stacked in the receptacle 1, 101, for example between about 350 and 500 nitrile gloves (rated at 6 Newtons tear strength), the stacking operation is paused, and the receptacle is removed from the work surface, either automatically or manually, and an empty receptacle is put in place at the work surface, and the operation described above is repeated.

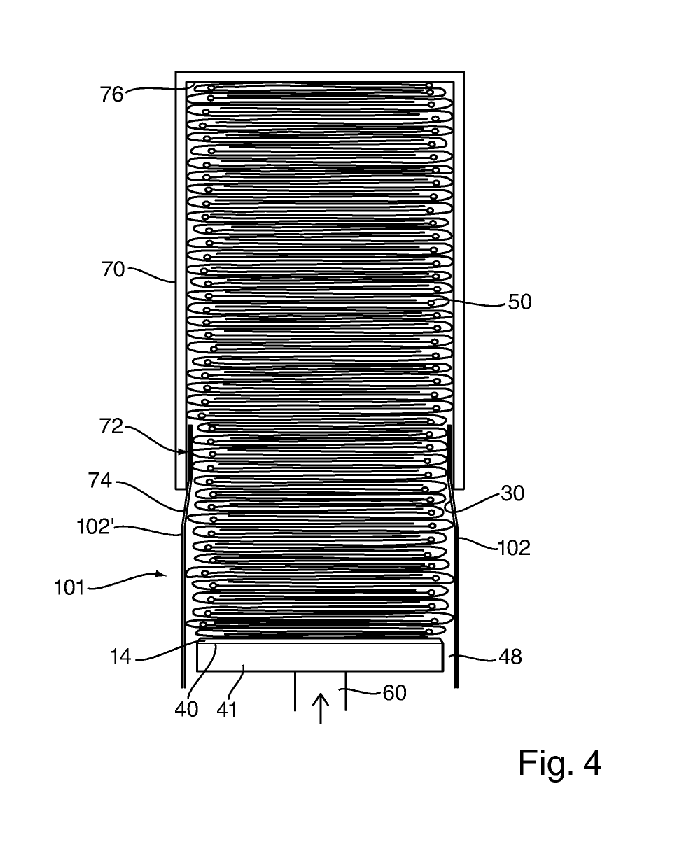

Once the gloves are stacked in the receptacle 1, 101, the stacked gloves may be removed from the receptacle into a container 70, as illustrated in FIG. 4 in respect of the second embodiment. The gloves are removed from the receptacle by placing an open mouth 72 of the container 70 over the receptacle and moving the base 41 upwards to press the stacked gloves 50 into the open container. The container is shown only schematically in outline, and may consist of a single box-like component, referred to as a packing box, for example made from a rigid plastics material, into which the stacked gloves are temporarily packed, prior to transfer into a glove dispensing box. Alternatively, the container 70 may be a glove dispensing box having a dispensing aperture and made, for example, from a card material, in which case flaps of the box may be closed and sealed after filling of the box with gloves, or the container 70 may be an open plastic bag made from plastic film material which has a closable opening that is closed after packing with the glove stack to form a glove packet for refilling a reusable glove dispensing box. In a further variation, the container 70 may comprise more than on box-like or bag-like component, one inside the other. For example, the container 70 may be a rigid packing box which holds and provides external support for the open glove dispensing box or the open plastic bag. All of these different possibilities are represented symbolically in the drawing by the outline schematic container 70.

In the case of a 500 interfolded glove stack, the container 70 will be about 250 mm high in the direction of the axis 120, and about 115 mm by 125 mm in width and depth, so that the gloves may ultimately be packed inside a suitable glove dispenser, for example a card material glove dispensing box having dimensions 120 mm by 130 mm by 230 mm.

As shown in FIG. 4, the opening 72 of the container 70 is first inserted over the sleeve halves 102, 102′ so that an inside base 76 of the container is opposite the opening 110 to the receptacle 101. The container opening is dimensioned to fit snugly over the sleeve halves and rest on an outer angled band 74 that corresponds with the inner angled band 30. This arrangement automatically ensures that the packed gloves can be fully compressed against the base 76 of the container 70 when the floor 40 and packing plate 14 reaches to or just marginally beyond the opening 110 to the receptacle 101.

During the process the stack is compressed first by the interaction with the overhang provided by the angled surfaces and secondly by the compression against the container base 76, and so air is expelled from the stack 50 in a two-stage process. This increases the efficiency in expelling air from the stack with the result that it becomes possible in a machine automation packing process to pack more gloves in a card material box dispenser than has hitherto been feasible.

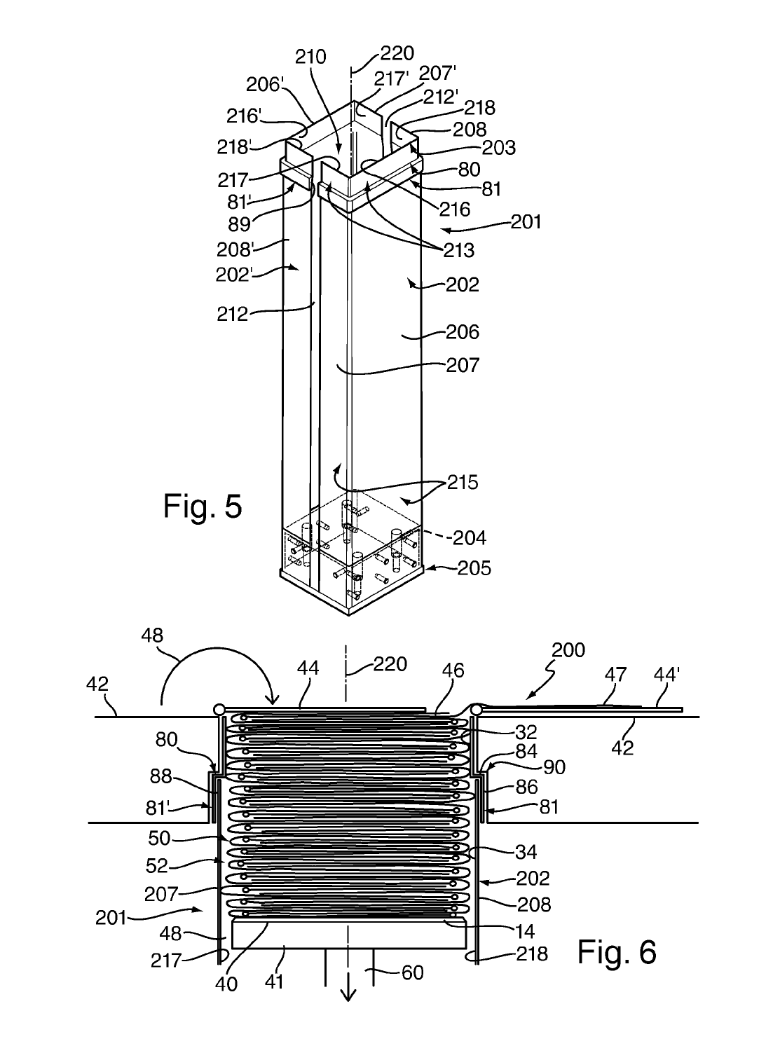

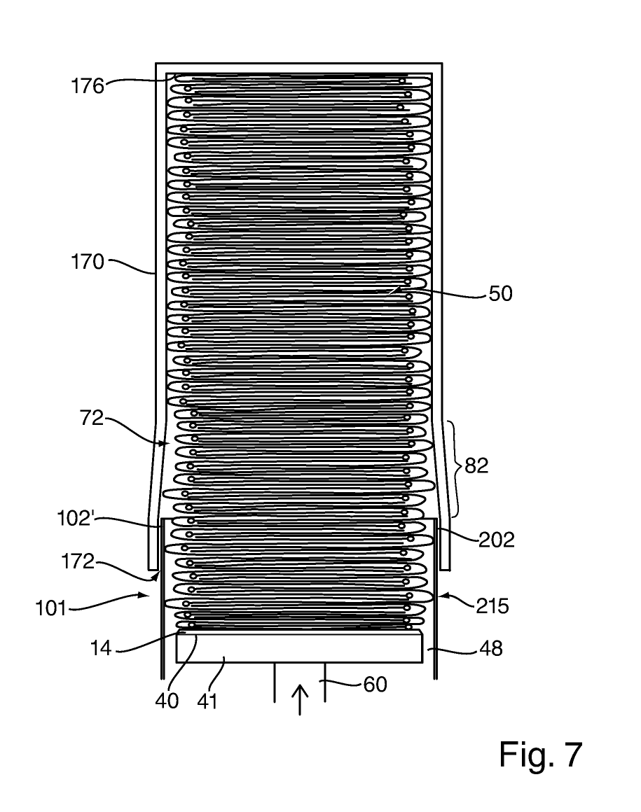

FIG. 5 is perspective view of a third embodiment of a receptacle 201 for use in a glove stacking apparatus. In the second embodiment features of the receptacle which correspond with those of the first embodiment are indicated by reference numerals incremented by 200.

The third embodiment of the receptacle 201 differs from the first and second embodiments 1, 101 in that the inner surfaces 216, 217, 218, 216′, 217′, 218′ of the partial side walls 207, 208, 207′ 208′ each have an angled surface that extends not at an acute angle to the packing axis 220, but at right angles to the packing axis at a step 80. The step defines the separation between the first and second portions 213, 215 in the receptacle sides.

A further difference is that the first side wall portion 213 is removably attached to the second receptacle side wall portion 215 at the step 80. As shown in FIG. 6, interior friction with the growing glove stack 50 is relieved at the step, where the interior dimensions of the receptacle 201 widen out. However, because the step 80 is at a right angle, instead of being tapered, the step could provide unwanted resistance to upwards movement of the completed glove stack when this is to be removed from the receptacle 201.

Therefore, the parts of the receptacle 201 forming the first portion 213 of the sides is first removed from the second portion 215 of the sides prior to placing an open mouth 172 of the container 170 over the receptacle and moving the base 41 upwards to press the stacked gloves 50 into the open packing box, as described above. The container 170 may consist of a packing box that is provided with a tapered section 82 near the opening or mouth 172 of the packing box. This tapered section then provides inward compression of the glove stack as the stack is transferred to the inside of the packing box.

Optionally, the container 172 may take different forms, as described above in relation to the first embodiment. The container 172 may, for example, be a substantially rigid packing box in combination with an open glove dispensing box that is held inside the packing box during this packing operation.

The container may, alternatively, be just a glove dispensing box or a plastic bag, in which case, instead of having a tapered section, the glove dispensing box or the plastic bag would have a mouth that was either wide enough or flexible enough to accommodate the dimensions of the second portion 215 of the receptacle sides. However, in the case of a plastic bag, it is preferable if the plastic bag is supported by a surrounding substantially rigid packing box.

The removable first portion 213 of the receptacle sides may be joined to the second portion 215 in a variety of different ways, for example by clips, catches, or by an interference or friction fit of the components forming the first and second portions 213, 215 of the receptacle 201. Because the slots 212, 212′ extend fully to the receptacle opening 210, there are two similar halves 81, 81′ to the removable first portion of the receptacle, each half having the same shape and form, which like that of the receptacle halves 202, 202′, is that of a square C-shape when viewed from above along the packing axis 220.

The step 80 is formed from an outwardly directed flange 84 that extends from a section of side wall nearest the opening that is parallel with the packing axis 220. The flange terminates at a downwardly directed lip 86, also parallel with the packing axis, which makes a close sliding fit with an uppermost rim 88 of the second portion 215 of the receptacle sides. This therefore restrains the first portion 213 in a downwards direction along the packing axis.

Each half 81, 81′ is retained in a transverse direction away from the packing axis by means of a lip return 89 which extends generally towards the packing axis from each of the ends of the lip 86, so that each lip return 89 wraps partly around and engages with the edges of each slot 212, 212′ in the vicinity of the uppermost rim 88 of the second portion.

As shown in FIG. 6, when seated inside the work surface 42 of a glove stacking apparatus 200, the removable first portions 81, 81′ may be retained in an upwards direction parallel with the packing axis 220 by means of a ledge 90 inside the work surface 42 which matches the outer profile of the step 80.

Although not illustrated, the second embodiment 101 of the invention described above may be modified to have a removable first portion 113, and this may have the same form as that 213 of the third embodiment 201 except that the right angle step 80 would be replaced with a surface set at an acute angle to the packing axis, similar to that of the angled band 30.

In all embodiments, the floor 40 is separated from adjacent side surfaces of the receptacle by a gap 48. The invention allows this gap to be made larger than in the acknowledged prior art, as the angled surfaces also serve to laterally compress the glove stack 50 as this is moved in a direction towards the receptacle opening 10, 110 or, as in the case of the third embodiment 201, the end of the second portion 215 of each side after removal of the first portion 213 of each side.

In all embodiments, the receptacle halves 2, 2′ are formed from smooth sheet stainless steel, and to further reduce friction, the inside surfaces are preferably coated with PTFE or a similar friction reducing coating.

It should be noted that although the receptacle sides define the opening to the receptacle, it is not necessary that the side surfaces extend fully around the interior portions of the receptacle away from the opening. In the preferred embodiments, the receptacle sides are cut by a pair of slots, which extend even into the vicinity of the opening. Additional slots in the sides could be provided, particularly in the second portion of the receptacle away from the opening. It may even be possible in the second portion to reduce the extent of one or more of the sides to that of an elongate bar extending parallel or substantially parallel with the packing axis. There may be several of such bars, in the manner of a cage. The reduction in the surface area of the sides in the second portion will further reduce sliding friction. The second portion sides may therefore have any configuration, and be provided in any number, as long as these sides extend away from the opening and are sufficient to contain the stack of gloves as this is built up inside the receptacle.

In the examples disclosed above, the gloves are interfolded with just one transverse fold. The invention is, however, applicable to other types of interfolding, for example the S-fold type interfolding disclosed in WO 2012/085704 A1 in which there are two transverse folds at approximately the one-third and two-third points between the finger tips and the end of the glove cuff. This type of interfolding also produces a glove stack in which the finger portion of each glove loops around the cuff portion of the next glove to be dispensed. However, in this case the stack of gloves will be narrower in the direction transverse to the fold lines.

The person skilled in the art will also appreciate that the particular dimensions of the glove stacking receptacle will depend on the desired dimensions of the glove stack, and this will depend on the type of interfolding and also on other factors, for example if the glove is folded in half in a longitudinal direction or if there is any inward folding the glove portions for the little finger or thumb, all of which would have the effect of narrowing the glove stack in a particular direction.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable combination.

It is to be recognized that various alterations, modifications, and/or additions may be introduced into the constructions and arrangements of parts described above without departing from the spirit or scope of the present invention, as defined by the appended claims.

The invention therefore provides a convenient apparatus and method for stacking gloves prior to packing in a dispensing box.

1. A glove stacking apparatus for preparing a stack of gloves prior to packing into a container, comprising a receptacle inside of which said stack is to be formed, the receptacle comprising:
an opening to the receptacle for receiving gloves added to said stack of gloves;
a floor within the receptacle, the floor being opposite the opening for supporting said stack of gloves and being movable relative to the opening, so that, in use, the floor may be moved relatively away from said opening so that as gloves are added to said stack of gloves said stack remains within the receptacle and so that when the stack of gloves is complete the floor may be moved relatively toward said opening to remove the stack of gloves from the receptacle, the movement of said floor within the receptacle thereby defining a packing axis of the receptacle; and
a plurality of sides, said sides defining said opening and having corresponding side surfaces that extend away from the opening for containment of said stack within the receptacle;
wherein at least one of said sides comprises a first portion proximate said opening and a second portion that is relatively farther away from said opening than said first portion, said side having an angled side surface that is at an angle to the packing axis such that said angled surface extends inwardly towards the packing axis from said second portion towards said first portion of said side.

2. A glove stacking apparatus as claimed in claim 1, in which said angled surface is angled at an acute angle to the packing axis.

3. A glove stacking apparatus as claimed in claim 1, in which said first portion is parallel with the packing axis, said first portion being proximate said opening and said angled surface extending from said second portion in a direction that is both towards the opening and towards from the packing axis.

4. A glove stacking apparatus as claimed in claim 2 or claim 3, in which said angled surface is a ramp between adjacent portions of said side surface, said adjacent portions being substantially parallel with the packing axis.

5-8. (canceled)

9. A glove stacking apparatus as claimed in any preceding claim, in which the receptacle has four sides, and the first portion forms a band that extends across at least two of said sides.

10. A glove stacking apparatus as claimed in claim 9, in which said at least two sides comprise two opposite sides of the receptacle.

11. A glove stacking apparatus as claimed in claim 1, in which the angled surface extends substantially the full distance between the opening and floor when the floor is moved away from the opening, the angled surface being a surface that is sloped relative to the packing axis.

12. A glove stacking apparatus as claimed in claim 1, in which the angled surface extends substantially the full distance between the opening and floor when the floor is moved away from the opening, the angled surface being set at an angle of between 0.3° and 1.5° to the packing axis.

13. A glove stacking apparatus as claimed in claim 12, in the angled surface is set at an angle of between 0.9° and 1.1° to the packing axis.

14. A glove stacking apparatus as claimed in any preceding claim, in which the a movable floor is provided by a base, the apparatus comprising additionally an actuator, said actuator being arranged to move the base towards the opening when the stack is completed and the base having dimensions such that the base does not contact said side surfaces of the receptacle as the stack is moved towards the opening.

15. A glove stacking apparatus as claimed in claim 1, in which said angled surface is a step that extends substantially perpendicular to the packing axis.

16. A glove stacking apparatus as claimed in claim 15, in which said angled surface is a step between adjacent portions of said side surface, said adjacent portions being substantially parallel with the packing axis.

17. A glove stacking apparatus as claimed in claim 15 or claim 16, in which the first portion is removeably attached to the second portion so that said angled surface can be removed from the receptacle in order to aid the removal of the stack of gloves when the floor is moved relatively towards the opening.

18. A glove stacking apparatus as claimed in any preceding claim, in which the receptacle proximate the opening is a sleeve having outer side surfaces, and the shape of the outer side surfaces parallels the shape of the side surfaces inside the sleeve so that at least one of said outer side surfaces comprises an angled outer surface of the sleeve.

19. A glove stacking apparatus as claimed in claim 18, comprising additionally a container, the container having therein a base and opposite the base an opening for receiving therein the sleeve so that said stack of gloves can be transferred to the container when the stack of gloves is complete and the floor is moved towards the opening of the receptacle, wherein the opening of the container rests on said angled outer surface of the sleeve when the sleeve is received inside the opening of the container.

20. (canceled)

21. A method of using a glove stacking apparatus to prepare a stack of gloves prior to packing into a container, the apparatus comprising a receptacle having an opening and a floor opposite and relatively movable with respect to said opening and inside said opening a plurality of sides, said sides extending around the opening and having corresponding side surfaces and at least one of said side surfaces including an angled surface that forms an overhang within the receptacle, the method comprising the steps of:
inserting gloves one or more at a time through the opening and into the receptacle to build a stack of gloves that is supported by the floor, said stack having a height that extends from the floor towards the opening and having a width and a depth in orthogonal directions that are perpendicular to the height of the stack, at least one of the width and depth of the stack being defined by contact between said stacked gloves with at least one side around the opening;
moving the floor as necessary away from the opening as the stack of gloves is built up so that said stack continues to be contained within the receptacle;
wherein friction owing to said contact between said at least one side and the stack of gloves is relieved for those gloves which pass the overhang as the floor is moved relatively away from the opening.

22. A method as claimed in claim 21, in which the method comprises,
when the stack of gloves is complete, moving the floor towards said opening in order to remove said completed stack from the receptacle and during said removal using said overhang to compresses inwardly those gloves which had previously passed the overhang.

23. A method as claimed in claim 22, comprising the step of using the frictional contact between said at least one side and the stack of gloves to resist the movement of said stack towards the opening in order to compress said stack between the floor and the overhang and thereby expel air from within said stack.

24. A method as claimed in claim 23, in which the apparatus comprises a container, the container having a base therein and opposite said base an opening, the method comprising the steps of:
placing the container opening over the receptacle opening;
receiving said stack within the container as the floor moves relatively towards the opening; and
using the movement of the floor to compress said received stack against the base and thereby expel air from within said stack.

25. A method as claimed in any one of claims 21 to 24, in which the receptacle has four sides with corresponding side surfaces within the receptacle and the overhang extends on all four of said side surfaces, at least one of the width and depth of the stack being defined by contact between said stacked gloves with at least two opposite sides around the opening, the method comprising the step of using contact between said stacked gloves with said at least two sides around the opening to stabilize the orientation of a portion of the stack between the overhang and the movable floor.
